(19) United States
(12) Patent Application Publication
(10) Pub. No.: US 2007/0163789 A1
(43) Pub. Date: Jul. 19, 2007

(54) Cultivator/tiller

(75) Inventor: Clinton Charles Thackery, South Carolina, CA (US)

Correspondence Address: BRINKS HOFER GILSON & LIONE, P.O. BOX 10395, CHICAGO, IL, 60610, US

(73) Assignee: EASTWAY FAIR COMPANY LIMITED

(21) Appl. No.: 11/334,177

(22) Filed: Jan. 17, 2006

(51) Int. Cl. A01B 33/00

(52) U.S. Cl. 172/42

(57) ABSTRACT

A cultivator/tiller having an ergonomic handle is provided. The cultivator/tiller includes a motor adapted to drive at least one tine and a handle attached to the forward end of the housing, wherein the motor is attached to the rearward end of a housing. The ergonomic handle includes a pair of spaced apart arms, and the arms have a first end and a second end. The ergonomic handle also includes a transverse member attached to the second end of each arm. Furthermore, both ends of each arm are curved relative to the longitudinal direction of the elongated portion of the arms.

### TECHNICAL FIELD

This invention relates to garden cultivator/tillers, and more particularly, to a cultivator/tiller having an ergonomic handle.

### BACKGROUND OF THE INVENTION

Cultivator/tillers are instruments typically used in gardening or farming to turn and rotate the soil so that the nutrients can be redistributed and combined with soil lacking these nutrients due to depletion from plants. Cultivator/tillers are also used in the spring to turn the soil such that the dead plant growth from the previous season is put into the ground to provide fertilizing nutrients for the present year's crop. Cultivator/tillers have a plurality of tines, or spokes, that are adapted to rotate about a pivot axis and are inserted and removed from the ground in order to loosen the soil.

Typical cultivator/tillers have a motor that is operatively connected to a housing, or body, and tillage tines in order to drive the tines. A handle is attached to the body at a location behind the motor and extends rearward therefrom. When servicing the cultivator/tiller, such as replacing or repairing damaged tines or to clean the cultivator/tiller, it is often necessary to rotate the cultivator/tiller to an inverted, or upside-down, position to have direct access to the tines. However, a disadvantage of having the handle mounted rearward of the motor is that when the cultivator/tiller is inverted, the motor, gas tank, and spark plug remain exposed and are vulnerable to damage as the cultivator/tiller is rotated.

A cultivator/tiller typically has a pair of graspable, spaced-apart handles to which the user grasps to control and maneuver the cultivator/tiller. These handles provide limited angles at which the user can grasp the handles in order to reduce the fatigue and stress directed toward the wrists and hands of the user. A disadvantage of this type of handle is that the user is unable to adjust the orientation of the position of their hands as they grasp the handle. Additionally, the typical known handle configurations make it difficult to invert the cultivator/tiller for servicing as they do not provide a stable base.

### BRIEF SUMMARY

The present invention solves one or more of the shortcomings above by providing a handle that is ergonomically shaped and protects the components of the motor as the cultivator/tiller is inverted during servicing and provides a stable base when inverted. The embodiments described herein provide the user with a plurality of possible angles at which the user's hands can be oriented as the user grasps the handle, thus providing an ergonomic handle. In addition, the embodiments described herein also provide a handle that allows the cultivator/tiller to be inverted for servicing without damaging the motor or components thereof due to contact with the ground as the cultivator/tiller is inverted.

In one aspect of the invention, a cultivator/tiller is provided, and the cultivator/tiller includes a motor configured to rotate at least one tine. The motor is attached to the rearward end of a housing, and a handle is attached to the forward end of the housing.

In another aspect of the invention, an ergonomic handle for a cultivator/tiller is provided. The handle includes a pair of spaced apart arms, and each of the arms has a first end and a second end. The handle further includes a transverse member that is attached to second end of each of the arms, and is oriented in a transverse direction to the longitudinal direction of the arms. The transverse member forms a handle to which the user can grasp during use. Both the first end and second end of each of the arms are curved relative to the longitudinal direction of the arms.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a top perspective view of one embodiment of a cultivator/tiller;

FIG. 2 is a is a left side view of the cultivator/tiller of FIG. 1;

FIG. 3 is a right side view of the cultivator/tiller thereof;

FIG. 4 is a front view of the cultivator/tiller thereof;

FIG. 5 is a rear view of the cultivator/tiller thereof;

FIG. 6 is a top view of the cultivator/tiller thereof;

FIG. 7 is a bottom view of the cultivator/tiller thereof;

FIG. 8 is an exploded view of one embodiment of the handle for a cultivator/tiller;

FIG. 9 is a top perspective view of the lower portion of the housing and the lower member of the handle; and

FIG. 10 is an exploded view of the housing and the lower member of the handle.

### DETAILED DESCRIPTION OF THE DRAWINGS AND THE PRESENTLY PREFERRED EMBODIMENTS

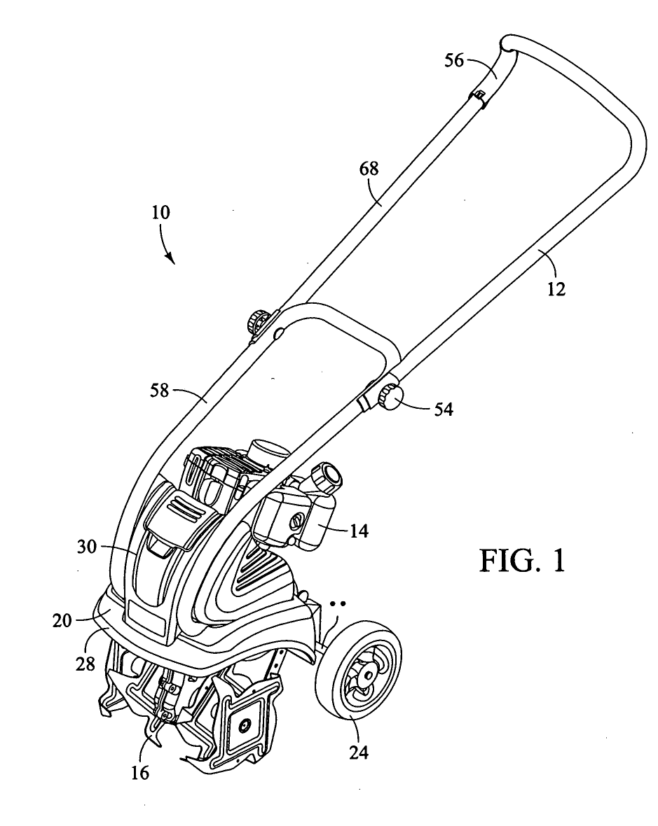

Referring to FIGS. 1-7, one embodiment of a cultivator/tiller 10 is shown. The cultivator/tiller 10 includes a handle 12, a motor 14, tillage tines 16, a structural framework 18, and a housing 20. The structural framework 18 includes a pivot member 22, a wheel 24 connected to each distal end of the pivot member 22, and a base member 26 extending from the pivot member 22. The structural framework 18 provides a foundation to which the remaining components of the cultivator/tiller 10 are operatively connected. The structural framework 18, motor 14, and tillage tines 16 are all described hereinafter in exemplary embodiments, as it should be understood by one skilled in the art that any type of structural framework, motor, or tillage tine configuration sufficient to perform the task of tilling can be used. The present invention is not limited by the type of motor or tillage tines used.

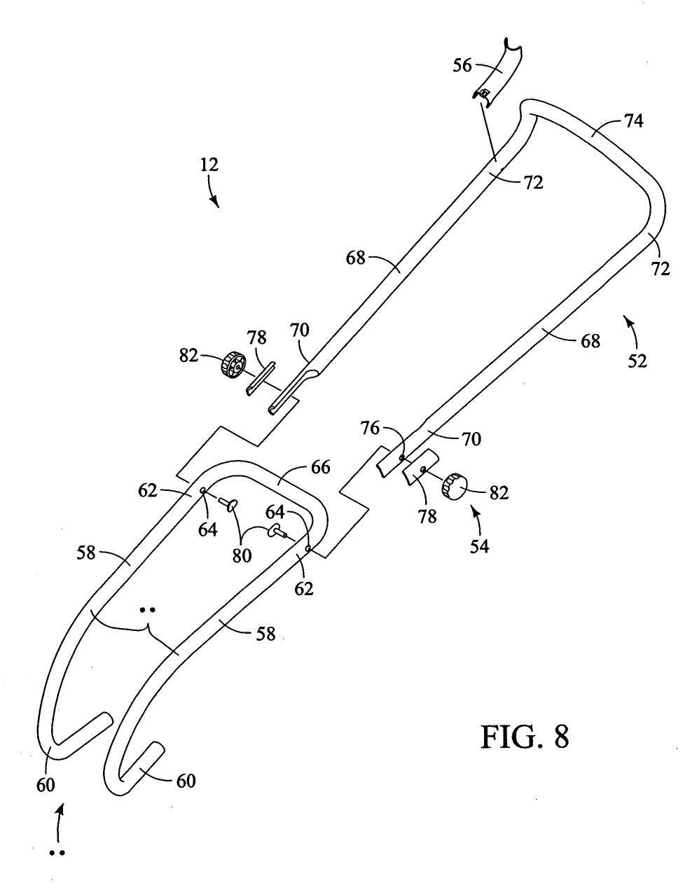

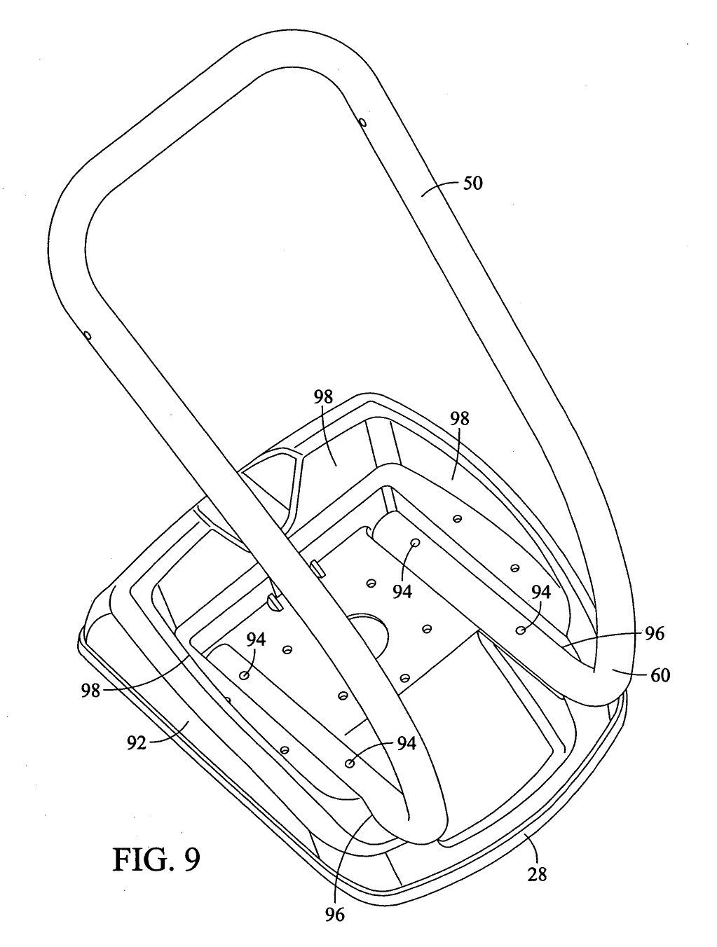

The handle 12, as illustrated in FIG. 8, preferably includes a lower member 50, an upper member 52, a connecting assembly 54, and a control member 56. The handle 12 is operatively connected to the housing 20 and the structural framework 18 and provides a graspable surface by which a user can control the direction of the cultivator/tiller 10. The overall shape of the handle 12 is designed to provide the user with an ergonomic gripping surface to reduce the strain on the user's hands and wrists during operation of the cultivator/tiller 10. In the preferred embodiment, the handle 12 is a two-piece structure in which a lower member 50 is attached to the housing 20 and an upper member 52 is configured to be grasped by a user.

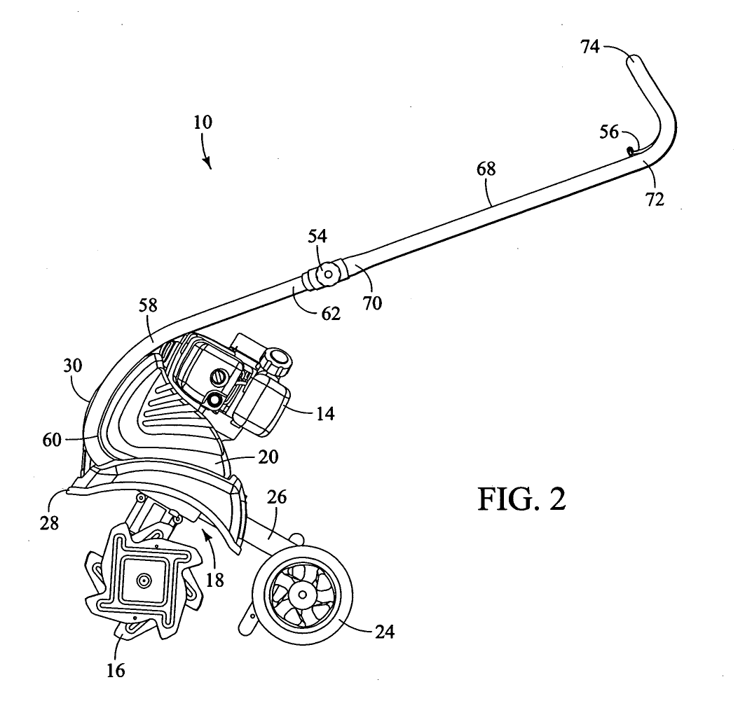

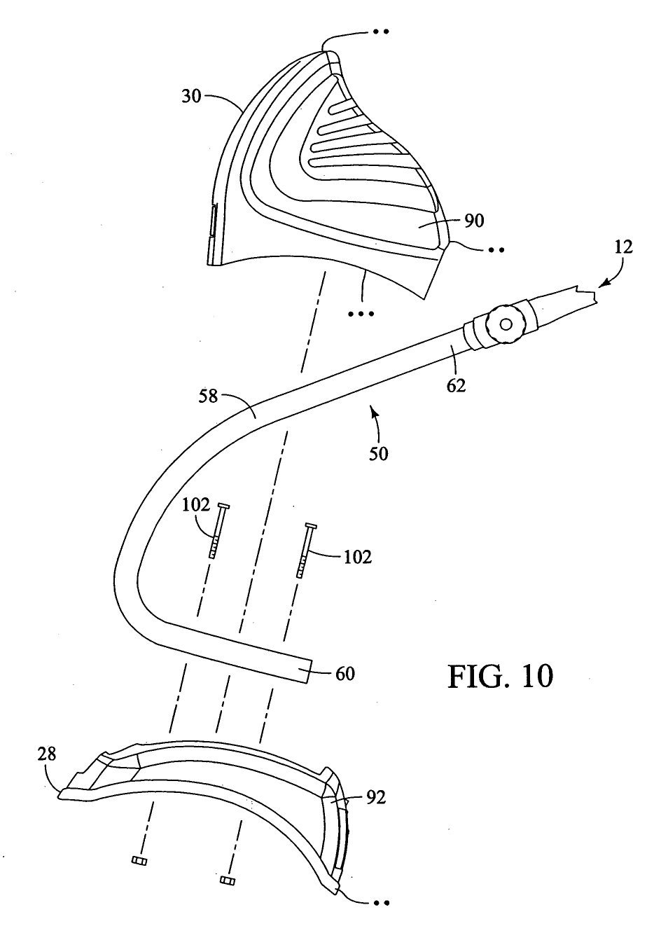

The lower member 50 is preferably formed of a curved tubular structure and includes a pair of spaced-apart legs 58, each having a first end 60 and a second end 62, as shown in FIG. 8. A first transverse member 66 extends between the first legs 58 in a transverse direction relative to the longitudinal direction defined by the substantially straight, central portion 59 of the legs 58. The legs 58 and the first transverse member 66 form a continuous, single-piece structure. It should be understood by one skilled in the art that the lower member can be formed with any number of separate members such that the first transverse member can be either fixedly or removably attached to both of the legs. Each leg 58 has an elongated central portion 59 located between the first end 60 and second end 62, and the central portion 59 is substantially linear, thereby defining a longitudinal direction, or centerline, of each leg 58. The first ends 60 of the legs 58 are configured to be attached to the housing 20. The first ends 60 of the legs 58 are preferably curved such that the first ends 60 form a generally U-shaped, or hooked structure. However, it should be understood by one skilled in the art that the angle at which the first ends 60 are oriented relative to the longitudinal direction of the legs can vary. The first ends 60 are curved such that the distal end of the first ends 60 are directed at an angle between about ninety (90) and one hundred-eighty (180) with respect to the longitudinal direction of the legs 58. The curvature of the first ends 60 of the legs 58 maintains a substantially coplanar relationship with the central portion 59 of the respective leg 58. The U-shaped curvature of the first ends 60 of the legs 58 allows the lower member 50 to follow the outer contour of the housing 20, as illustrated in FIGS. 2 and 10.

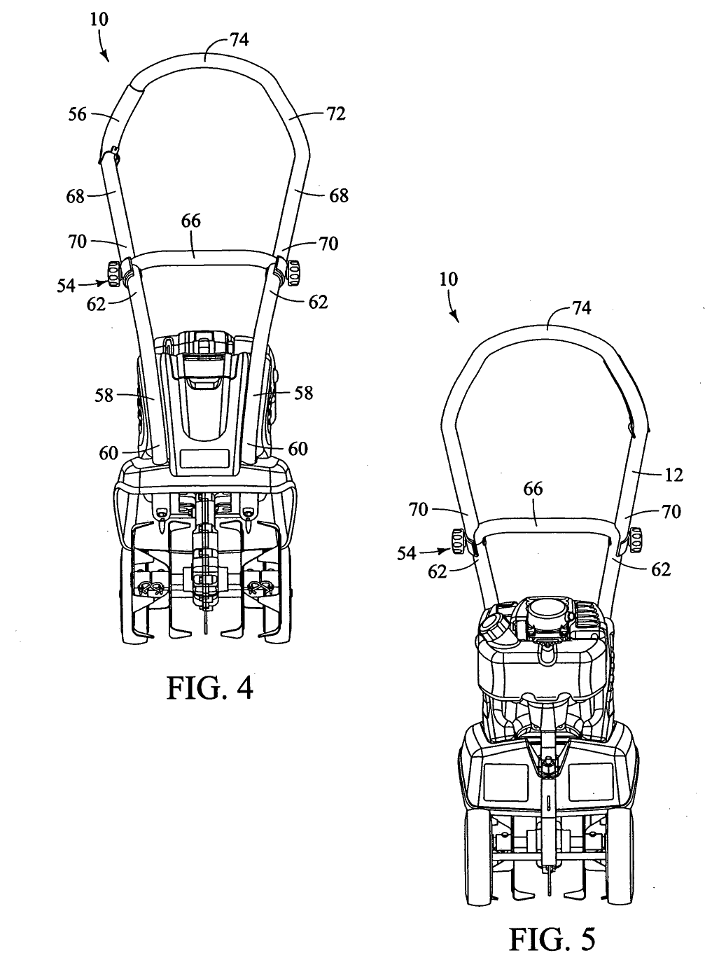

The second ends 62 of the legs 58 of the lower member 50 are configured to provide a structure to which the upper member 52 is attached, as illustrated in FIG. 8. Each of the second ends 62 of the legs 58 have an aperture 64 defined therethrough. The apertures 64 are oriented in a direction transverse to the longitudinal direction of the legs 58. The apertures 64 are configured to receive the connecting assembly 54, thereby attaching the upper member 52 to the lower member 50. The second ends 62 of the legs 58 are preferably spaced apart with respect to each other a greater distance in the transverse direction than the first ends 60 of the legs 58, thereby forming an angle between the centerline of each leg 58, as shown in FIGS. 4-5. As the legs 58 extend from the housing 20, the distance between the legs 58 increases. In an alternative embodiment the legs 58 are configured to be substantially parallel to each other as they extend from the housing.

The first transverse member 66 extends in a substantially transverse direction relative to the longitudinal direction of the legs 58, and the first transverse member 66 connects the second ends 62 of the legs 58 of the lower member 50. The continuous section of the lower member 50 forms a generally U-shaped cross member that spans the distance between the second end 62 of each leg 58. It should also be understood by one skilled in the art that the lower member 50 need not include a first transverse member 66, but instead can include only the spaced apart leg 58 with no transverse member connected between the second ends 62 therebetween.

The upper member 52, as illustrated in FIG. 8, includes a pair of spaced apart arms 68 each of the arms 68 having a first end 70 and a second end 72, a second transverse member 74, and a control member 56 being attached to the second end 72 of one of the arms 68. The two arms 68 and the second transverse member 74 of the upper member 52 preferably form a continuous hollow tube, wherein the first ends 70 of the arms 68 are configured to be attached to the lower member 50. It should be understood by one skilled in the art that the upper member 52 can include a plurality of members connected together to form the upper member 52. The second ends 72 of the arms 68 are preferably spaced apart with respect to each other a greater distance in the transverse direction than the first ends 70, thereby forming an angle between the longitudinal centerlines of the arms 68, as illustrated in FIGS. 4-5. As the arms 68 extend from the lower member 50, the distance between the arms 68 increases. It should be understood by one skilled in the art that the arms 68 can be configured to be substantially parallel to each other.

The inwardly-facing surface of each of the first ends 70 of the arms 68 of the upper member 52 that is directed toward the opposing arm 68 is preferably cut out in the longitudinal direction such that the first ends 70 form a semi-circular surface that is configured to be attached to the lower member 50, as illustrated in FIG. 8. The cut-out surface of the first ends 70 correspond to the outer surfaces of the second ends 62 of the legs 58 of the lower member 50 such that the second ends 62 of the lower member 50 abut, and are partially surrounded by, the cut-out portions of the first ends 70 of the upper member 52. Each of the first ends 70 of the arms 68 of the upper member 52 have an aperture 76 defined therethrough in a direction transverse to the longitudinal direction of the arms 68. The apertures 76 are configured to receive the connecting assembly 54 so as to attach the upper member 52 to the lower member 50. The apertures 64 of the lower member 50 are configured to be aligned with the apertures 76 of the upper member 52 when the handle 12 is assembled.

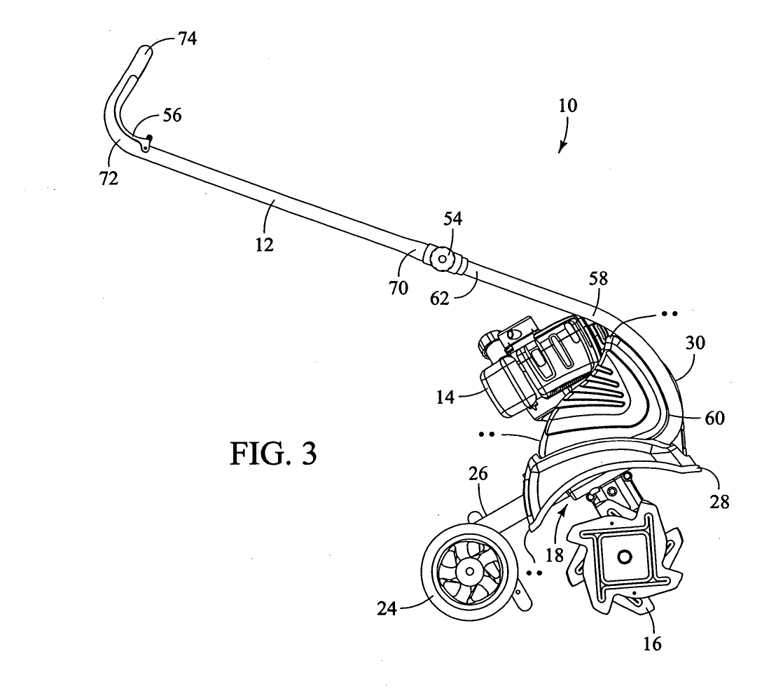

The second ends 72 of the arms 68 of the upper member 54 are connected by the second transverse member 74. The second transverse member 74 is preferably integrally formed with the arms 68 such that the arms 68 and the transverse member 74 forms a continuous structural member, as illustrated in FIG. 8. The upper member 52 is preferably formed by a hollow tube. The second ends 72 of the arms 68 are curved in both an upward and inward manner relative to the longitudinal direction of each of the arms 68. The second ends 72 thus define a radius of curvature such that the second transverse member 74 is oriented at a substantially right-angle with respect to the arms 68, as shown in FIGS. 2-3. The second ends 72 of the arms 68 are also curved inward with respect to the opposing arm 68, as shown in FIGS. 4-5. The second transverse member 74 provides at least two different locations at which the user can grasp the second transverse member 74, wherein the first being the inward-directed ends of the second transverse member 74 adjacent to the second ends 72 of the arms 68 and the second being the central portion of the second transverse member 74 that aligned in a substantially horizontal manner. The second transverse member 74 has a soft material, such as rubber or foam, surrounding the outer surface of the second transverse member 74, thereby providing a buffer between the user's hands and the transverse member 74. In an alternative embodiment (not shown), the second ends 72 of the arms 68 can be curved in both a downward and inward manner relative to the longitudinal direction of the arms 68, such that the graspable second transverse member 74 is disposed vertically beneath the second ends 72 of the arms 68. In a further alternative embodiment, the upper member 52 can be formed such that the second transverse member 74 is removably attached to the opposing arms 68. In a further alternative embodiment, the second transverse member 74 is fixedly attached to the spaced apart arms 68 by a weld, or a similar method of attachment.

The upper member 52 is connected to the lower member 50 by way of a connecting assembly 54, as illustrated in FIG. 8. The connecting assembly 54 is adapted to attach each of the first ends 70 of the upper member 52 to a corresponding second end 62 of the lower member 50. The arms 68 of the upper member 52 are aligned such that they are substantially co-linear with the legs 58 of the lower member 50. Each connecting assembly of the preferred embodiment includes a spacer 78, a pin 80, and a rotatable knob 82. The spacer 78 is disposed between the outer surface of the first end 62 of an arm 58 and a rotatable knob 54. The spacer 78 is preferably a rectangular structure that is curved such that the inner surface of the spacer 78 abuts the outer surface of the first end 70 of the arm 68. In an alternative embodiment, the spacer 78 can be a typical circular washer, or any other structure sufficient to act as a buffer between the knob 82 and the arm 68. A threaded pin 80 is inserted from the inward-facing surface of the leg 58 through an aperture 64 defined in the second end 62 of a leg 58, through the aligned aperture 76 in the first end 70 of the arm 68, through the aperture defined in the spacer 78, and is received by the knob 82 having threads corresponding to those on the pin 80. The knob 82 is rotated to receive the pin 80, thereby generating axial tension along the length of the pin 80 to secure the upper member 52 to the lower member 50. A connecting assembly 54 is preferably used to connect both of the first ends 70 of the upper member 52 to the corresponding second ends 62 of the lower member 50. In an alternative embodiment, the connecting assembly 54 can include a bolt having a smooth outer surface disposed through the apertures 76, 64, and a cotter pin inserted transversely through the bolt, thereby connecting the upper-member 52 to the lower member 50.

The control mechanism 56 is preferably attached to the portion of a second end 72 of an arm 68 of the upper member 54, as illustrated in FIGS. 3 and 8. The control mechanism 56 is operatively connected to the motor 14, thereby controlling the motor 14 and the speed of rotation of the tillage tines 16. One distal end of the control mechanism 56 is pivotally attached to the second end 72 of an arm 68, and the opposing distal end of the control mechanism 56 is configured to be gripped by the user in a pivotal manner. In an alternative embodiment, the control mechanism 56 is operatively connected to the second transverse member 74 such that control mechanism is oriented substantially horizontal and parallel to the second transverse member 74. It should be understood by one skilled in the art that the control mechanism 56 can be disposed at any position on the upper member 52 of the handle 12 such that the user can operate the control mechanism 56 with one hand while grasping the handle 12 with the same hand. The control mechanism 56 has a semi-cylindrical shape such that the inner surface of the control mechanism 56 abuts the outer surface of the second end 72 of the arm 68 when the user grips the control mechanism. A spring (not shown) is operatively connected to the control mechanism such that the distal end of the control mechanism that is opposite the end connected to the arm 68 is biased away from the second end 72 of the arm 68.

The control mechanism 56 has an operative position and a stop position. The stop position is achieved when the spring biases the control mechanism 56 away from the arm 68, thereby stopping the motor from causing the tillage tines from rotating regardless of whether the motor is running. The operative position is achieved when the user grasps the control mechanism 56 in a gripping manner such that the control mechanism abuts the arm 68, thereby causing the motor to rotate the tillage tines when the motor is running.

The upper member 52 and lower member 50 of the handle 12 are preferably made of a hollow steel tube. In the alternative, the upper and lower members 50, 52 can be made of aluminum, stainless steel, composite materials, or any other material sufficient to withstand the bending loads that are applied to the handle 12 during the use of the cultivator/tiller 10. Additionally, the upper and lower members 50, 52 can have a solid cross-section. The housing 20 is preferably made of injection molded plastic. However, it should be understood by one skilled in the art that the housing can be made of any material sufficient to withstand the forces applied by the handle 12 as well as contact with loose material or particles that are directed toward the housing by the tines during operation of the cultivator/tiller; the materials including, but not limited to, polyester resin, rubber, or a metal.

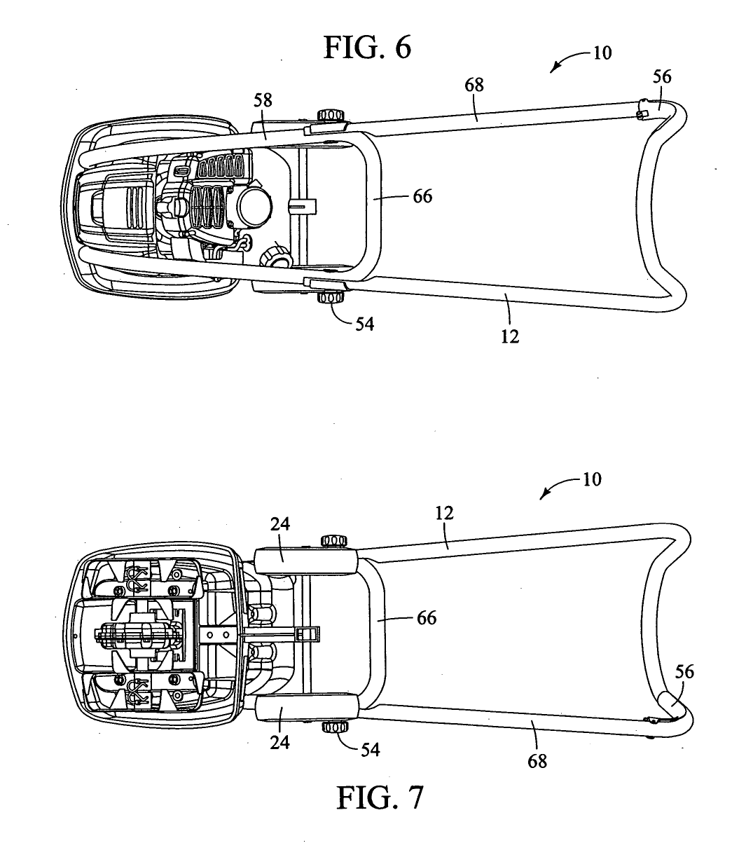

The housing 20, as illustrated in FIGS. 1-3, is configured to provide protection to the user by surrounding the tillage tines 16 so as to contain loose particles during use as well as act as a guard for the driving mechanisms that operatively connect the motor 14 to the tillage tines 16. The housing 20 includes a front edge 28, a front face 30, a rear edge 32, a rear face 34, and a top edge 36 connecting the front face 30 and the rear face 34, as illustrated in FIGS. 3 and 10. The front edge 28 of the housing 20 extends in a forward direction from the base member 26 such that the front edge 28 of the housing 20 extends substantially the same distance as the tines 16. The front face 30 of the housing 20 extends upward from the front edge 28, and is slightly curved in the rearward direction as the front face 30 extends upwardly, as illustrated in FIGS. 2-3. The rear face 34 of the housing 20 forms a generally elongated S-shaped surface, and the motor is located adjacent to the rear face 34 of the housing 20, as illustrated in FIGS. 3 and 6. It should be understood by one skilled in the art that the housing 20 can be of any shape sufficient to contain loose particles that are expelled by the tines 16 during use of the cultivator/tiller 10.

The housing 20 includes an upper portion 90 and a lower portion 92, as illustrated in FIG. 10. The lower portion 92 of the housing 20 is configured to receive the first ends 60 of the lower member 50 of the handle 12, as illustrated in FIGS. 9-10. The lower portion 92 of the housing 20 has a pair of elongated channels 96 that are elongated and substantially cylindrically-shaped having the top portion opened such that the first ends 60 of the lower member 50 can be disposed within the channels 96 when assembled. As shown in FIG. 9, each of the first ends 60 of the lower member 50 have a pair of apertures 94 defined therethrough. The lower member 50 is secured to the lower portion 92 of the housing 20 by a nut-and-bolt assembly 102 passing through the apertures 94 defined in the first ends 60 of the lower member 50 and corresponding apertures defined in the lower portion 92 of the housing 20, as illustrated in FIG. 10. In an alternative embodiment, the first ends 60 of the handle 12 are not U-shaped, but provide an angle between the first ends 60 and the substantially linear portion of the legs 58, and the first ends 60 are attached to the front portion of the housing 20 such that first ends 60 are not disposed between the upper portion 90 and lower portion 92 of the housing.

The lower portion 92 of the housing has a continuous inner surface 98 that extends along one side, across the back portion, and along the opposing side of the lower portion 92. The upper portion 90 has an outer surface 100 that corresponds to the inner surface 98 of the lower portion 92 of the housing 20. Assembly of the housing preferably includes locating the upper portion 90 of the housing 20 immediately adjacent to the lower portion 92 of the housing 20 such that the inner surface 98 abuts and corresponds to the outer surface 100 of the upper portion 90. In the preferred embodiment, a clamp (not shown) having a hook is attached to, and extends upwardly, from the lower portion 92 of the housing. The hook portion of the clamp is configured to contact an inner surface of the upper portion 92 of the housing 20, thereby securing the upper portion 92 to the lower portion 90. The clamp is attached to the lower portion 92 by a bolt. In an alternative embodiment, when the inner surface 98 and outer surface 100 are adjacent to each other, a bolt (not shown) is disposed through the upper portion 90, the lower portion 92, and the structural framework 18 such that both the upper portion 90 and the lower portion 92 are secured to each other as well as the framework of the cultivator/tiller 10.

As shown in FIGS. 2-3 and 10, the U-shaped first ends 60 of the lower member 50 of the handle 12 are configured to be attached to the lower portion 92 of the housing 20, and the longitudinal portions of the legs 58 extend along the contour of the front face 30 of the upper portion 90 of the housing 20 in an abutting manner and proceed to extend in the rearward direction away from the top edge 36 of the housing 20. The legs 58 are located adjacent to the front surface 30 such that the legs 58 protrude slightly outward from the housing 20. In the preferred embodiment, the handle 12 is disposed vertically above the motor 14 in a spaced-apart manner.

The shape of the handle 12 as it extends along the front surface 30 of the upper portion 90 of the housing 20 and extends rearward therefrom provides the cultivator/tiller with structural members which contact the ground when the cultivator/tiller 10 is rotated to an inverted position in order to repair or replace the tines 16. Thus, as the cultivator/tiller 10 is rotated in a forward direction, the first ends 60 of the lower member 50 adjacent to the front edge 28 of the housing 20 contact the ground and provide a gap between the ground and the housing 20 such that the housing 20 does not come into contact with the ground. As the cultivator/tiller 10 is further rotated in the forward direction, the central, substantially linear portion 59 of the legs 58 contacts the ground, and continue to provide a gap between the ground and the motor 14. Thus, in the preferred embodiment, an advantage of the handle 12 extending over the top edge 36 of the housing 20 and the motor 14 is that the handle 12 prevents damage to the motor 14 by maintaining the motor in a spaced-apart relationship with the ground such that the motor does not come into contact with the ground as the cultivator/tiller is rotated to an inverted position. This configuration also provides a stable base for when the cultivator/tiller 10 is in an inverted position.

One embodiment of an ergonomic handle includes an upper member 52 and a lower member 50. The upper member 52 having a pair of spaced-apart arms 68 connected by a transverse member 74, and the lower member 50 having a pair of spaced-apart legs 58 connected by a transverse member 66, wherein the arms 68 and legs 58 are attached in a substantially collinear manner. The first ends 60 of the legs 58 of the lower member 50 are curved in a downward direction relative to the legs 58, forming a generally U-shaped end. The second ends 72 of the upper member 52 are curved in an upward and an inward direction relative to the arms 68. The transverse member 74 being disposed between the second ends 72 of the upper member 52 forms a graspable surface, and the graspable surface provides the user with a variety of locations at which the user's hands can grip the ergonomic handle.

One embodiment of an engine-protecting handle includes a handle 12 extending along the front face 30 of the housing 20 such that the outer surface of the handle 12 protrudes slightly away from the front face 30 of the housing 20. When the cultivator/tiller 10 is in an inverted position, the protruding portion of the handle 12 provides a gap between the ground and the front face 30 of the housing 20. In addition, as the handle 12 extends rearward beyond the top edge 36 the motor 14 is spaced-apart from the handle 12 such that the handle maintains a gap between the motor 14 and the ground when the cultivator/tiller 10 is in an inverted position.

While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

1. A cultivator/tiller comprising:
a motor;
at least one tine being operatively connected to said motor;
a housing having a front face and a rear face, and said motor being attached adjacent to said rear face of said housing; and
a handle attached to said housing, wherein said handle is adjacent to said front face of said housing.

2. The cultivator/tiller of claim 1, wherein said handle extends in a rearward direction from said housing.

3. The cultivator/tiller of claim 2, wherein said handle is spaced apart from said motor in a vertical direction as said handle extends rearward.

4. The cultivator/tiller of claim 1, wherein said handle includes a pair of spaced apart arms.

5. The cultivator/tiller of claim 4, wherein said handle has a transverse member adapted to provide a graspable surface.

6. The cultivator/tiller of claim 5, wherein said transverse member is attached to both of said spaced apart arms.

7. The cultivator/tiller of claim 6, wherein said handle is a continuous member.

8. The cultivator/tiller of claim 7, wherein said handle is formed of a hollow tube.

9. The cultivator/tiller of claim 1, wherein said handle further comprises an upper member and a lower member.

10. The cultivator/tiller of claim 9, wherein said lower member is attached to said housing, and said upper member is attached to said lower member.

11. The cultivator/tiller of claim 10, wherein said upper member is attached to said lower member by a connecting assembly.

12. The cultivator/tiller of claim 1, wherein said housing includes an upper portion and a lower portion, and said upper portion having a front face and a rear face.

13. The cultivator/tiller of claim 12, wherein said handle has a U-shaped end.

14. The cultivator/tiller of claim 13, wherein said U-shaped end of said handle is attached to said lower portion of said housing.

15. The cultivator/tiller of claim 14, wherein said U-shaped end of said handle is disposed between said upper portion and said lower portion.

16. The cultivator/tiller of claim 15, wherein said handle extends from said lower portion and is adjacent to said front face of said upper portion.

17. The cultivator/tiller of claim 16, wherein said front face has a contour, and said handle follows said contour of said front face.

18. The cultivator/tiller of claim 17, wherein said handle extends rearward from said housing, and is located above said motor and having a vertically oriented gap between said handle and said motor.

19. An ergonomic handle for a cultivator/tiller comprising:
a pair of spaced apart arms, said arms having a first end and a second end, wherein said second ends are curved in a downward direction relative to a longitudinal direction of said arms;
a transverse member connecting said second ends of said arms, wherein said transverse member provides a graspable handle;
said first ends of said arms being curved relative to said longitudinal direction of said arms.

20. The ergonomic handle of claim 19, wherein said first ends are curved in an upward direction relative to said longitudinal direction of said arms.

21. The ergonomic handle of claim 20, wherein said second ends are curved inward toward a centerline between said arms.

22. The ergonomic handle of claim 19, wherein a second transverse member is connected to both of said arms in a transverse manner relative to said longitudinal direction of said arms.

23. A cultivator/tiller comprising:
a motor;
at least one tine being operatively connected to said motor;
a housing having a top edge, a front face and a rear face, wherein said top edge is adjacent to both said front face and said rear face, and said motor being attached adjacent to said rear face of said housing; and
a handle attached to said housing, wherein said handle extends adjacent to said front face of said housing and over said top edge in a rearward direction.

24. A cultivator/tiller comprising:
a motor;
a structural framework, said structural framework including a forward end and a rearward end, wherein said motor is attached to said framework adjacent to said rearward end;
at least one tine operatively connected to said motor; and
a means for providing a stable base when said cultivator/tiller is in an inverted position.

25. The cultivator/tiller of claim 24, wherein said means for providing a stable base when said cultivator/tiller is in, an inverted position is a handle.

26. The cultivator/tiller of claim 25, wherein said handle is attached to said forward end of said framework.

27. The cultivator/tiller of claim 26, wherein said handle is spaced apart from said motor such that when said cultivator/tiller is in said inverted position said handle maintains said motor in a position that is spaced apart from the ground.

28. The cultivator/tiller of claim 24 wherein said means for providing a stable base when said cultivator/tiller is in inverted position also provides a user with multiple grasping positions.

30. A cultivator/tiller comprising:
a motor;
a housing having a front face and a rear face, said motor being attached adjacent to said rear face; and
an ergonomic handle attached to said housing adjacent to said front face of said housing.

31. The cultivator/tiller of claim 30, wherein a first end of said ergonomic handle is generally U-shaped.

32. The cultivator/tiller of claim 31, wherein said U-shaped first end of said ergonomic handle is disposed within said housing.

33. The cultivator/tiller of claim 31, wherein a second end of said ergonomic handle is curved in a vertically upward direction.

34. The cultivator/tiller of claim 33, wherein said second end of said ergonomic handle provides a user with a plurality of locations to grasp said ergonomic handle.

35. The cultivator/tiller of claim 34, wherein a control mechanism adapted to control said motor is pivotally attached to said ergonomic handle.

36. The cultivator/tiller of claim 35, wherein said control mechanism has an operative position and a stop position.

37. The cultivator/tiller of claim 36, wherein said control mechanism abuts said ergonomic handle when said control mechanism is in said operative position.

38. A cultivator/tiller comprising:
a motor;
a housing having a front face and a rear face, said motor being attached adjacent to said rear face; and
an engine-protecting handle positioned adjacent to said front face.

39. The cultivator/tiller of claim 38, wherein said engine-protecting handle is configured to contact the ground such that when said cultivator/tiller is in an inverted position it is stable.

40. The cultivator/tiller of claim 39, wherein said engine-protecting handle maintains said motor in a spaced apart relationship with the motor when said cultivator/tiller is in an inverted position.
